(19) United States
(12) Patent Application Publication
(10) Pub. No.: US 2022/0076642 A1
(43) Pub. Date: Mar. 10, 2022

(54) DISPLAY DEVICE AND DISPLAY SYSTEM

(71) Applicant: Japan Display Inc., Tokyo (JP)

(72) Inventor: Yoshihiro Watanabe, Tokyo (JP)

(21) Appl. No.: 17/468,775

(22) Filed: Sep. 8, 2021

(30) Foreign Application Priority Data
Sep. 10, 2020 (JP) 2020-152416

(51) Int. Cl. G09G 3/36

(52) U.S. Cl. CPC G09G 3/36; G09G 2320/0209; G09G 2320/0271

(57) ABSTRACT

A display device includes a liquid crystal display panel having a display region, pixels provided in the display region and arranged in a matrix (row-column configuration) in a first direction and a second direction different from the first direction, and a pixel gradation corrector correcting a gradation value of a first pixel in accordance with gradation values of second pixels adjacent to the first pixel, the pixel gradation corrector multiplying a value indicating sensitivity with which the first pixel is influenced by the second pixels and a value indicating strength of influence that the second pixels exert on the first pixel together, and subtracting the multiplied value from an input gradation value of the first pixel to calculate an output gradation value to the first pixel.

### CROSS-REFERENCE TO RELATED APPLICATION

This application claims the benefit of priority from Japanese Patent Application No. 2020-152416 filed on Sep. 10, 2020, the entire contents of which are incorporated herein by reference.

### BACKGROUND

### 1. Technical Field

The present invention relates to a display device and a display system.

### 2. Description of the Related Art

A virtual reality (VR) system changes image display along with movement of a point of view to cause a user to feel a sense of virtual reality. As a display device to achieve such a VR system, disclosed is a technique mounting a head mounted display (hereinafter also referred to as an “HMD”) on the head and displaying images corresponding to the motion of the body or the like, for example (WO 2018/211672, for example).

In the HMD used in the VR system, a displayed image is enlarged by an eyepiece, and thus a display panel is required to have higher definition. The displayed image is enlarged, whereby gaps between pixels are likely to look like a grid. Thus, a liquid crystal display panel having a high pixel opening ratio is used as the display panel of the HMD, thereby producing the advantage that image display with a less sense of grid is enabled. In lateral electric field mode liquid crystal display panels such as in-plane switching (IPS) including fringe field switching (FFS), along with higher definition, there is a possibility that mutual electric lines of force exert influence on each other between adjacent pixels to cause color shift and a reduction in the accuracy of displayed colors.

What is disclosed herein has been made in view of the above problem, and an object thereof is to provide a display device and a display system that can inhibit a reduction in the accuracy of displayed colors along with higher definition.

### SUMMARY

A display device according to an embodiment of the present disclosure includes a liquid crystal display panel having a display region, pixels provided in the display region and arranged in a matrix (row-column configuration) in a first direction and a second direction different from the first direction, and a pixel gradation corrector correcting a gradation value of a first pixel in accordance with gradation values of second pixels adjacent to the first pixel, the pixel gradation corrector multiplying a value indicating sensitivity with which the first pixel is influenced by the second pixels and a value indicating strength of influence that the second pixels exert on the first pixel together, and subtracting the multiplied value from an input gradation value of the first pixel to calculate an output gradation value to the first pixel.

A display system according to an embodiment of the present disclosure includes a display device including a liquid crystal display panel having a display region, and pixels provided in the display region and arranged in a matrix (row-column configuration) in a first direction and a second direction different from the first direction, and an image generation device including a pixel gradation corrector correcting a gradation value of a first pixel in accordance with gradation values of second pixels adjacent to the first pixel, the pixel gradation corrector multiplying a value indicating sensitivity with which the first pixel is influenced by the second pixels and a value indicating strength of influence that the second pixels exert on the first pixel together, and subtracting the multiplied value from an input gradation value of the first pixel to calculate an output gradation value to the first pixel.

### BRIEF DESCRIPTION OF THE DRAWINGS

FIG. 1 is a configuration diagram of an example of a display system according to a first embodiment;

FIG. 2 is a schematic diagram of an example of a relation between a display panel and an eye of a user;

FIG. 3 is a block diagram of an example of components of an image generation device and a display device of the display system illustrated in FIG. 1;

FIG. 4 is a circuit diagram of a display region according to the first embodiment;

FIG. 5 is a schematic diagram of an example of the display panel according to the first embodiment;

FIG. 6 is a sectional view schematically illustrating a section of the display panel according to the first embodiment;

FIG. 7 is a diagram of a first example of a pixel arrangement according to the first embodiment;

FIG. 8 is a schematic sectional view of the display panel for illustrating influence by mutual electric lines of force between pixels adjacent to each other;

FIG. 9 is a diagram of display relative intensity in the case of white display and monochromatic display of a pixel of each color;

FIG. 10 is a diagram of a second example of the pixel arrangement according to the first embodiment;

FIG. 11 is a diagram of a third example of the pixel arrangement according to the first embodiment;

FIG. 12 is a block diagram of a pixel gradation correction circuit according to the first embodiment;

FIG. 13 is a diagram of an example of a function indicating sensitivity with which a pixel for which the pixel gradation will be corrected is influenced by adjacent pixels;

FIG. 14A is a diagram of an example of the shape of pixel electrodes in the first example of the pixel arrangement illustrated in FIG. 7;

FIG. 14B is a diagram of an example in which the shape of the pixel electrodes is different between an even row and an odd row in the first example of the pixel arrangement illustrated in FIG. 7; and

FIG. 15 is a block diagram of a pixel gradation correction circuit according to a second embodiment.

### DETAILED DESCRIPTION

The following describes aspects (embodiments) to perform the present disclosure in detail with reference to the accompanying drawings. The details described in the following embodiments do not limit the present disclosure. The components described in the following include ones that can easily be thought of by those skilled in the art and substantially the same ones. Further, the components described in the following can be combined with each other as appropriate. What is disclosed herein is only by way of example, and some appropriate modifications with the gist of the disclosure maintained that can easily be thought of by those skilled in the art are naturally included in the scope of the present disclosure. The drawings may be represented more schematically for the width, thickness, shape, and the like of parts than those of actual aspects in order to make the description clearer; they are only by way of example and do not limit the interpretation of the present disclosure. In the present specification and drawings, components similar to those previously described for the drawings previously described are denoted by the same symbols, and a detailed description may be omitted as appropriate.

### First Embodiment

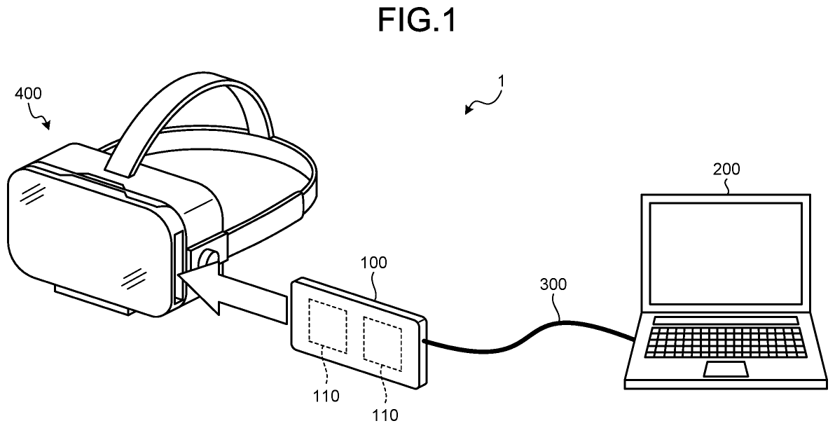

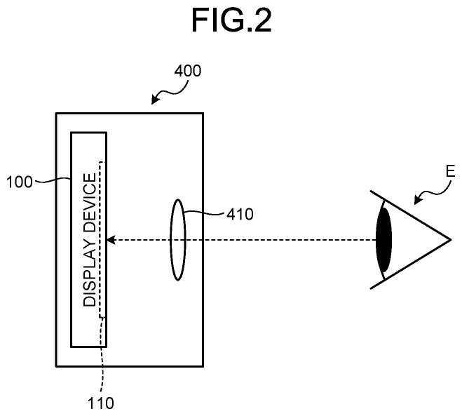

FIG. 1 is a configuration diagram of an example of a display system according to a first embodiment. FIG. 2 is a schematic diagram of an example of a relation between a display panel and an eye of a user.

In the present embodiment, this display system 1 is a display system changing display in accordance with the motion of the user. The display system 1 is a virtual reality (VR) system stereoscopically displaying a VR image indicating a three-dimensional object or the like on a virtual space and changing the stereoscopic display along with the direction (position) of the head of the user to cause the user to feel a sense of virtual reality, for example.

As illustrated in FIG. 1, the display system 1 has a display device 100 and an image generation device 200, for example. The display device 100 and the image generation device 200 are connected to each other in a wired manner via a cable 300, for example. The cable 300 includes a Universal Serial Bus (USB) or High-Definition Multimedia Interface (HDMI (registered trademark)) cable, for example. The display device 100 and the image generation device 200 may be connected to each other via wireless communications.

In the present disclosure, the display device 100 is used as a head mounted type display device fixed to a mounting member 400 and mounted on the head of the user, for example. The display device 100 includes a display panel 110 for displaying an image generated by the image generation device 200. In the following, the aspect in which the display device 100 is fixed to the mounting member 400 is also referred to as a “head mounted display (HMD)”.

In the present disclosure, examples of the image generation device 200 include personal computers and electronic apparatuses such as game machines. The image generation device 200 generates a VR image corresponding to the position or the attitude of the head of the user and outputs the VR image to the display device 100. The image generated by the image generation device 200 is not limited to the VR image.

The display device 100 is fixed at a position where when the user wears the HMD, the display panel 110 is placed before both eyes of the user. The display device 100 may include a voice output device such as a speaker at positions corresponding to both ears of the user when the user wears the HMD apart from the display panel 110. As described below, the display device 100 may include a sensor detecting the position, the attitude, or the like of the head of the user wearing the display device 100, or a gyro sensor, an acceleration sensor, or an azimuth sensor, for example. The display device 100 may contain the functions of the image generation device 200.

As illustrated in FIG. 2, the mounting member 400 has a lens 410 corresponding to both eyes E of the user, for example. The lens 410, when the user wears the HMD, magnifies an image displayed on the display panel 110 and forms the image on the eye E of the user. The user visually recognizes the image displayed on the display panel 110 and magnified by the lens 410. Although FIG. 2 illustrates an example in which one lens is placed between the eye E of the user and the display panel 110, a plurality of lenses corresponding to respective both eyes of the user may be included, for example. The display panel 110 may be placed at a position different from before the eye of the user.

In the present embodiment, the display panel 110 assumes a lateral electric field mode liquid crystal display panel such as in-plane switching (IPS) including fringe field switching (FFS) including an image liquid crystal element.

In the display device 100 used in the VR system illustrated in FIG. 1, as illustrated in FIG. 2, the image displayed on the display panel 110 is magnified and formed on the eye E of the user. Given this, a display panel with higher definition is demanded. The displayed image is magnified, whereby gaps between pixels are likely to look like a grid. Given this, using a liquid crystal display panel having a high pixel opening ratio brings about the advantage that image display with a less sense of grid is enabled.

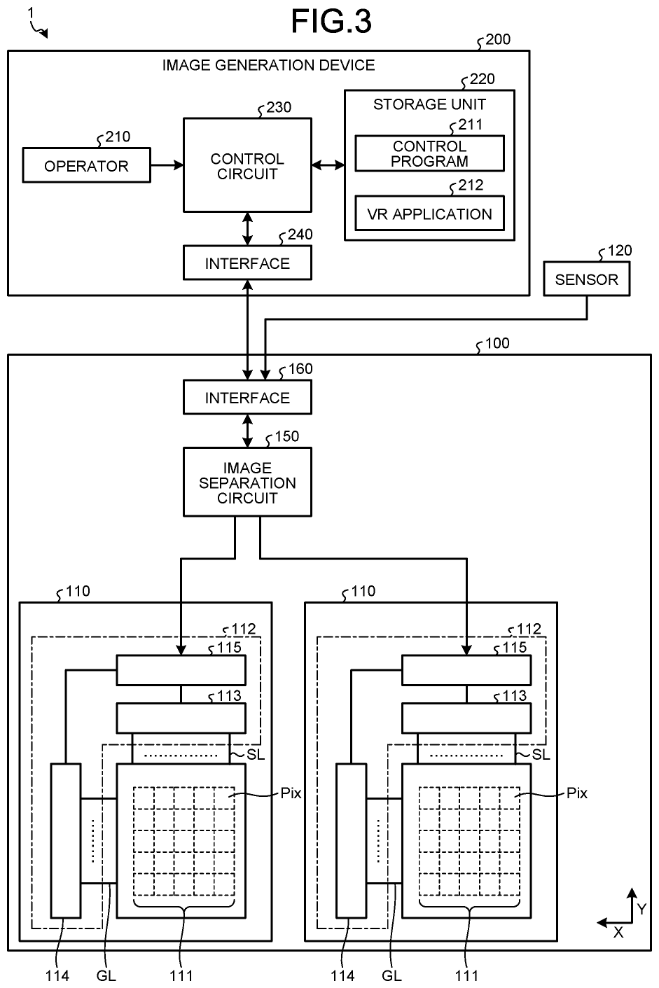

FIG. 3 is a block diagram of an example of components of the image generation device and the display device of the display system illustrated in FIG. 1. As illustrated in FIG. 3, the display device 100 includes two display panels 110, a sensor 120, an image separation circuit 150, and an interface 160.

The display device 100 includes the two display panels 110. As to the two display panels 110, one is used as the display panel 110 for the left eye, whereas the other is used as the display panel 110 for the right eye.

Each of the two display panels 110 has a display region 111 and a display control circuit 112. The display panel 110 has a light source device (not illustrated) illuminating the display region 111 from behind.

In the display region 111, P₀×Q₀ (P₀ in a row direction (an X direction) and Q₀ in a column direction (a Y direction)) pixels Pix are arranged in a two-dimensional matrix (row-column configuration). In the present embodiment, a pixel density of the display region 111 is 806 ppi, for example. FIG. 3 schematically illustrates the arrangement of a plurality of pixels Pix, and a detailed arrangement of the pixels Pix will be described below.

The display panel 110 has scan lines extending in the X direction and signal lines extending in the Y direction crossing the X direction. In the display panel 110, the pixels Pix are each placed in an area surrounded by signal lines SL and scan lines GL. The pixels Pix each have a switching element (thin film transistor (TFT)) connected to a signal line SL and a scan line GL and a pixel electrode connected to the switching element. A plurality of pixels Pix arranged along an extension direction of the scan line GL are connected to one scan line GL. A plurality of pixels Pix arranged along an extension direction of the signal line SL are connected to one signal line SL.

Out of the two display panels 110, the display region 111 of one display panel 110 is for the right eye, whereas the display region 111 of the other display panel 110 is for the left eye. Although this example exemplifies a case in which the display panel 110 has the two display panels 110 for the left eye and for the right eye, the display device 100 is not limited to the structure including two display panels 110. One display panel 110 may be employed, in which the display region of the one display panel 110 may be divided into two so that an image for the right eye is displayed on a right half region, whereas an image for the left eye is displayed on a left half region, for example.

The display control circuit 112 includes a driver integrated circuit (IC) 115, a signal line connection circuit 113, and a scan line drive circuit 114. The signal line connection circuit 113 is electrically connected to the signal lines SL. The driver IC 115 controls on and off of switching elements (TFTs, for example) for controlling the operation (light transmittance) of the pixels Pix by the scan line drive circuit 114. The scan line drive circuit 114 is electrically connected to the scan lines GL.

The sensor 120 detects information from which the orientation of the head of the user can be estimated. The sensor 120 detects information indicating the motion of the display device 100, whereas the display system 1 estimates the orientation of the head of the user wearing the display device 100 on the head based on the information indicating the motion of the display device 100, for example.

The sensor 120 detects information from which the orientation of the line of sight can be estimated using at least one of the angle, the acceleration, the angular velocity, the azimuth, and the distance of the display device 100, for example. For the sensor 120, a gyro sensor, an acceleration sensor, or an azimuth sensor can be used, for example. The sensor 120 may detect the angle and the angular velocity of the display device 100 by the gyro sensor, for example. The sensor 120 may detect the direction and the magnitude of acceleration acting on the display device 100 by the acceleration sensor, for example.

The sensor 120 may detect the azimuth of the display device 100 by the azimuth sensor, for example. The sensor 120 may detect the movement of the display device 100 by a distance sensor or a Global Positioning System (GPS) receiver, for example. The sensor 120 may be another sensor such as a light sensor or may be a combination of a plurality of sensors so long as it is a sensor for detecting the orientation of the head, a change in the line of sight, the movement, or the like of the user. The sensor 120 is electrically connected to the image separation circuit 150 via the interface 160 described below.

The image separation circuit 150 receives image data for the left eye and image data for the right eye sent from the image generation device 200 via the cable 300 and sends the image data for the left eye to the display panel 110 displaying the image for the left eye and sends the image data for the right eye to the display panel 110 displaying the image for the right eye.

The interface 160 includes a connector to which the cable 300 (FIG. 1) is connected. A signal from the image generation device 200 is input to the interface 160 via the connected cable 300. The image separation circuit 150 outputs a signal input from the sensor 120 to the image generation device 200 via the interface 160 and an interface 240. The signal input from the sensor 120 includes the information from which the orientation of the line of sight can be estimated described above.

Alternatively, the signal input from the sensor 120 may be output to a control circuit 230 of the image generation device 200 directly via the interface 160. The interface 160 may be a wireless communication device and may transmit and receive information to and from the image generation device 200 via wireless communication, for example.

The image generation device 200 includes an operator 210, a storage unit 220, the control circuit 230, and the interface 240.

The operator 210 receives operations by the user. The operator 210 can be an input device such as a keyboard, buttons, or a touch screen. The operator 210 is electrically connected to the control circuit 230. The operator 210 outputs information corresponding to the operations to the control circuit 230.

The storage unit 220 stores therein a computer program and data. The storage unit 220 temporarily stores therein a processed result of the control circuit 230. The storage unit 220 includes a storage medium. The storage medium includes a read only memory (ROM), a random access memory (RAM), a memory card, an optical disc, or a magnetooptical disc, for example. The storage unit 220 may store therein the data of an image to be displayed on the display device 100.

The storage unit 220 stores therein a control program 211 and a VR application 212, for example. The control program 211 can provide a function on various kinds of control to operate the image generation device 200, for example. The VR application 212 can provide a function to cause the display device 100 to display the VR image. The storage unit 220 can store therein various kinds of information input from the display device 100 such as data indicating a detection result of the sensor 120, for example.

The control circuit 230 includes a micro control unit (MCU) or a central processing unit (CPU), for example. The control circuit 230 can comprehensively control the operation of the image generation device 200. The various kinds of functions of the control circuit 230 are implemented based on the control of the control circuit 230.

The control circuit 230 includes a graphics processing unit (GPU) generating an image to be displayed, for example. The GPU generates an image to be displayed on the display device 100. The control circuit 230 outputs the image generated by the GPU to the display device 100 via the interface 240. Although the present embodiment describes a case in which the control circuit 230 of the image generation device 200 includes the GPU, this is not limiting. The GPU may be provided in the display device 100 or the image separation circuit 150 of the display device 100, for example. In this case, the display device 100 may acquire data from the image generation device 200, an external electronic apparatus, or the like, and the GPU may generate an image based on the data, for example.

The interface 240 includes a connector to which the cable 300 (refer to FIG. 1) is connected. A signal from the display device 100 is input to the interface 240 via the cable 300. The interface 240 outputs a signal input from the control circuit 230 to the display device 100 via the cable 300. The interface 240 may be a wireless communication device and may transmit and receive information to and from the display device 100 via wireless communication, for example.

Upon execution of the VR application 212, the control circuit 230 causes the display device 100 to display an image corresponding to the motion of the user (the display device 100). Upon detection of a change in the user (the display device 100) with the image displayed on the display device 100, the control circuit 230 changes the image displayed on the display device 100 to an image of the changed direction. The control circuit 230 creates an image based on a standard point of view and a standard line of sight on a virtual space at the time of starting creation of an image, when detecting the change in the user (the display device 100), changes the point of view or the line of sight when creating the displayed image from the standard point of view or the standard line of sight direction in accordance with the motion of the user (the display device 100), and causes the display device 100 to display an image based on the changed point of view or line of sight.

The control circuit 230 detects the movement of the head of the user to a right direction based on the detection result of the sensor 120, for example. In this case, the control circuit 230 changes the image being currently displayed to an image when the line of sight is changed to the right direction. The user can visually recognize an image in the right direction of the image being displayed on the display device 100.

Upon detection of the movement of the display device 100 based on the detection result of the sensor 120, the control circuit 230 changes the image in accordance with the detected movement, for example. When detecting that the display device 100 has moved toward the front, the control circuit 230 changes the image being currently displayed to an image when the display device 100 has moved to the front of the image being currently displayed. When detecting that the display device 100 has moved to a rear direction, the control circuit 230 changes the image being currently displayed to an image when the display device 100 has moved to the rear of the image being currently displayed. The user can visually recognize an image in its own moving direction from the image being displayed on the display device 100.

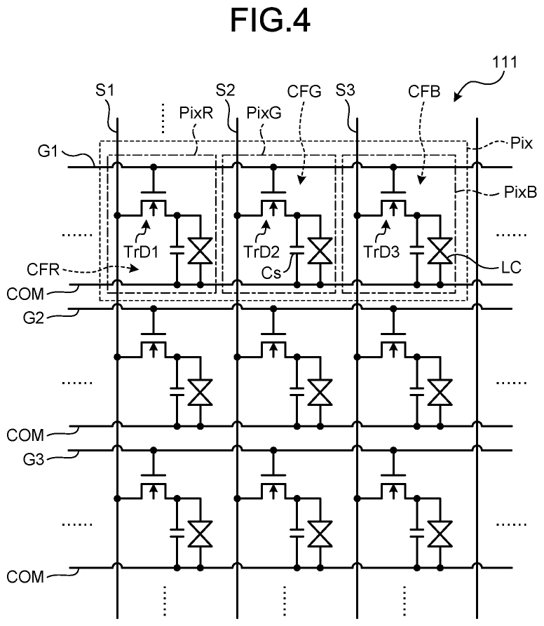

FIG. 4 is a circuit diagram of the display region according to the first embodiment. In the following, the scan lines GL described above collectively refer to a plurality of scan lines G1, G2, and G3. The signal lines SL described above collectively refer to a plurality of signal lines S1, S2, and S3. Although in the example illustrated in FIG. 4 the scan lines GL and the signal lines SL are orthogonal to each other, this is not limiting. The scan lines GL and the signal lines SL are not necessarily orthogonal to each other, for example.

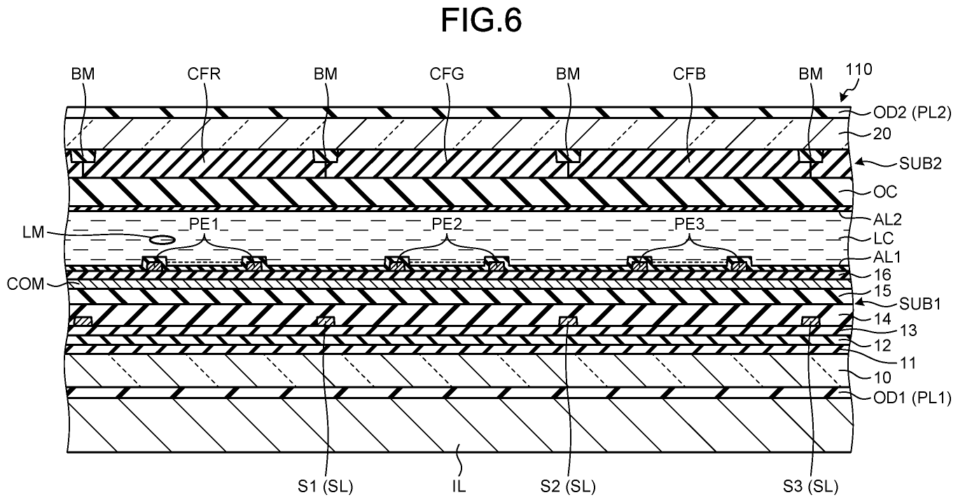

As illustrated in FIG. 4, in the present disclosure, the pixel Pix includes a pixel PixR for displaying red (a first color: R), a pixel PixG for displaying green (a second color: G), and a pixel PixB for displaying blue (a third color: B), for example. In the display region 111, switching elements TrD1, TrD2, and TrD3 of the pixels PixR, PixG, and PixB, respectively, the signal lines SL, the scan lines GL, and the like are formed. The signal lines S1, S2, and S3 are wires to supply pixel signals to pixel electrodes PE1, PE2, and PE3 (refer to FIG. 6). The scan lines G1, G2, and G3 are wires to supply gate signals driving the switching elements TrD1, TrD2, and TrD3.

The pixels PixR, PixG, and PixB include the switching elements TrD1, TrD2, and TrD3, respectively, and each include a capacitance of a liquid crystal layer LC. The switching elements TrD1, TrD2, and TrD3 include thin film transistors and, in this example, include n-channel metal oxide semiconductor (MOS) TFTs. A sixth insulating film 16 (refer to FIG. 6) is provided between the pixel electrodes PE1, PE2, and PE3 described below and a common electrode COM, which form a holding capacitance Cs illustrated in FIG. 4.

In color filters CFR, CFG, and CFB illustrated in FIG. 4, color regions colored in three colors of red (the first color: R), green (the second color: G), and blue (the third color: B) are periodically arranged, for example. The R, G, and B three-color color regions are associated with the pixels PixR, PixG, and PixB illustrated in FIG. 4 described above as one group. The pixels PixR, PixG, and PixB corresponding to the three-color color regions are defined as a set of pixels Pix. The color filters may include four-or-more-color color regions.

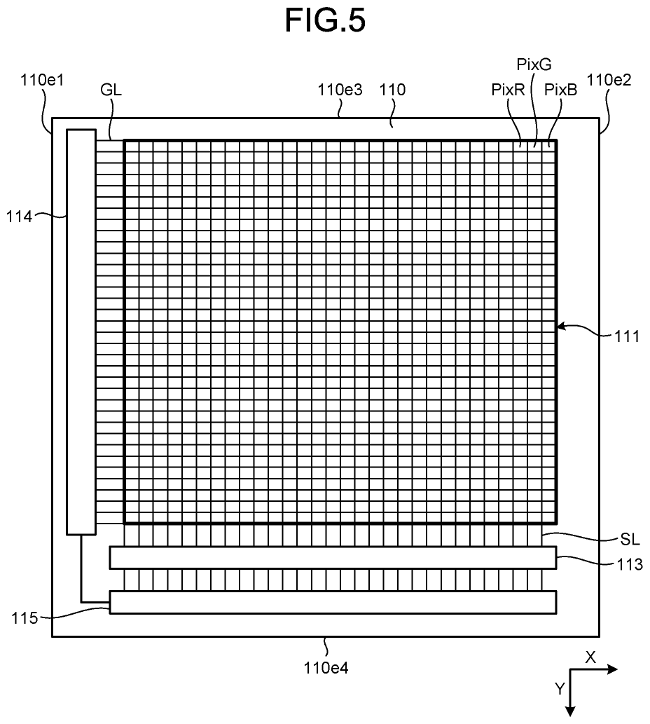

FIG. 5 is a schematic diagram of an example of the display panel according to the first embodiment. FIG. 6 is a sectional view schematically illustrating a section of the display panel according to the first embodiment.

As illustrated in FIG. 5, the display panel 110 has substrate end sides 110e1, 110e2, 110e3, and 110e4. The region between the substrate end sides 110e1, 110e2, 110e3, and 110e4 and the display region 111 of the display panel is called a peripheral region.

The scan line drive circuit 114 is placed in the peripheral region between the substrate end side 110e1 and the display region 111 of the display panel 110. The signal line connection circuit 113 is placed in the peripheral region between the substrate end side 110e4 and the display region 111 of the display panel 110. The driver IC 115 is placed in the peripheral region between the substrate end side 110e4 and the display region 111 of the display panel 110. In the present embodiment, the substrate end sides 110e3 and 110e4 of the display panel 110 are parallel to the X direction. The substrate end sides 110e1 and 110e2 of the display panel 110 are parallel to the Y direction.

In the example illustrated in FIG. 5, the signal lines SL extend parallel to the Y direction, whereas the scan lines GL extend parallel to the X direction. As illustrated in FIG. 5, in the present disclosure, the direction in which the scan lines GL extend is orthogonal to the direction in which the signal lines SL extend, and thus the pixels PixR, PixG, and PixB are each a rectangular, for example. Although the example illustrated in FIG. 5 exemplifies a case in which the pixels PixR, PixG, and PixB are each a rectangular, they are not limited to a rectangular. The pixels PixR, PixG, and PixB may each be a parallelogram, for example. The pixels PixR, PixG, and PixB may also be referred to as a pixel PixS.

The following describes a sectional structure of the display panel 110 with reference to FIG. 6. In FIG. 6, an array substrate SUB1 has a first insulating substrate 10 having translucency such as a glass substrate or a resin substrate as a base. The array substrate SUB1 includes a first insulting film 11, a second insulating film 12, a third insulating film 13, a fourth insulting film 14, a fifth insulating film 15, the sixth insulating film 16, the signal lines S1 to S3, the pixel electrodes PE1 to PE3, the common electrode COM, a first orientation film AL1, and the like on a side facing a counter substrate SUB2 of the first insulating substrate 10. In the following description, the direction from the array substrate SUB1 toward the counter substrate SUB2 is referred to as an upper direction or simply as upper.

The first insulting film 11 is positioned on the first insulating substrate 10. The second insulating film 12 is positioned on the first insulting film 11. The third insulating film 13 is positioned on the second insulating film 12. The signal lines S1 to S3 are positioned on the third insulating film 13. The fourth insulting film 14 is positioned on the third insulating film 13 to cover the signal lines S1 to S3.

If necessary, wiring may be placed on the fourth insulting film 14. This wiring will be covered with the fifth insulating film 15. The present embodiment omits the wiring. The first insulting film 11, the second insulating film 12, the third insulating film 13, and the sixth insulating film 16 are formed of an inorganic material having translucency such as a silicon oxide or a silicon nitride, for example. The fourth insulting film 14 and the fifth insulating film 15 are formed of a resin material having translucency and have larger thicknesses than those of the other insulating films formed of the inorganic material. However, the fifth insulating film 15 may be formed of the inorganic material.

The common electrode COM is positioned on the fifth insulating film 15. The common electrode COM is covered with the sixth insulating film 16. The sixth insulating film 16 is formed of an inorganic material having translucency such as a silicon oxide or a silicon nitride, for example.

The pixel electrodes PE1 to PE3 are positioned on the sixth insulating film 16 and face the common electrode COM via the sixth insulating film 16. The pixel electrodes PE1 to PE3 and the common electrode COM are formed of a conductive material having translucency such as indium tin oxide (ITO) or indium zinc oxide (IZO), for example. The pixel electrodes PE1 to PE3 are covered with the first orientation film AL1. The first orientation film AL1 also covers the sixth insulating film 16.

The counter substrate SUB2 has a second insulating substrate 20 having translucency such as a glass substrate or a resin substrate as a base. The counter substrate SUB2 includes a light shielding layer BM, the color filters CFR, CFG, and CFB, an overcoat layer OC, a second orientation film AL2, and the like on a side of the second insulating substrate 20 facing the array substrate SUB1.

As illustrated in FIG. 6, the light shielding layer BM is positioned on the side of the second insulating substrate 20 facing the array substrate SUB1. The light shielding layer BM defines the size of respective openings facing the pixel electrodes PE1 to PE3. The light shielding layer BM is formed of a black resin material or a light shielding metallic material.

The color filters CFR, CFG, and CFB are positioned on the side of the second insulating substrate 20 facing the array substrate SUB1, and each end thereof overlaps with the light shielding layer BM. The color filter CFR faces the pixel electrode PE1. The color filter CFG faces the pixel electrode PE2. The color filter CFB faces the pixel electrode PE3. As an example, the color filters CFR, CFG, and CFB are formed of resin materials colored in blue, red, and green, respectively.

The overcoat layer OC covers the color filters CFR, CFG, and CFB. The overcoat layer OC is formed of a resin material having translucency. The second orientation film AL2 covers the overcoat layer OC. The first orientation film AL1 and the second orientation film AL2 are formed of a material indicating horizontal orientation, for example.

As described in the foregoing, the counter substrate SUB2 includes the light shielding layer BM, the color filters CFR, CFG, and CFB, and the like. The light shielding layer BM is placed at regions facing wiring parts such as the scan lines G1, G2, and G3 and the signal lines S1, S2, and S3 illustrated in FIG. 4, contact parts PA1, PA2, and PA3, and the switching elements TrD1, TrD2, and TrD3.

Although in FIG. 6 the counter substrate SUB2 includes the three-color color filters CFR, CFG, and CFB, it may include four-or-more-color color filters including color filters of other colors different from blue, red, and green such as white, transparent, yellow, magenta, and cyan. The array substrate SUB1 may include the color filters CFR, CFG, and CFB.

Although in FIG. 6 the counter substrate SUB2 is provided with the color filters CF, a structure of what is called a color filter on array (COA), in which the array substrate SUB1 is provided with the color filters CF, may be employed.

The array substrate SUB1 and the counter substrate SUB2 described above are placed such that the first orientation film AL1 and the second orientation film AL2 face each other. The liquid crystal layer LC is enclosed between the first orientation film AL1 and the second orientation film AL2. The liquid crystal layer LC includes a negative liquid crystal material, the dielectric anisotropy of which is negative, or a positive liquid crystal material, the dielectric anisotropy of which is positive.

The array substrate SUB1 faces a backlight unit IL, whereas the counter substrate SUB2 is positioned on a display face side. As the backlight unit IL, ones of various kinds of aspects can be used; a description of its detailed structure is omitted.

A first optical element OD1 including a first polarizing plate PL1 is placed on an outer face of the first insulating substrate 10 or a face facing the backlight unit IL. A second optical element OD2 including a second polarizing plate PL2 is placed on an outer face of the second insulating substrate 20 or a face on an observation position side. A first polarization axis of the first polarizing plate PL1 and a second polarization axis of the second polarizing plate PL2 are in a positional relation of crossed Nicol on an X-Y plane, for example.

The first optical element OD1 and the second optical element OD2 may include other optical functional elements such as a phase plate.

When the liquid crystal layer LC is the negative liquid crystal material, and no voltage is applied to the liquid crystal layer LC, for example, liquid crystal molecules LM are initially oriented in a direction such that their long axis is along the X direction within the X-Y plane. On the other hand, when voltage is applied to the liquid crystal layer LC, that is, at the time of on, in which electric fields are formed between the pixel electrodes PE1 to PE3 and the common electrode COM, the liquid crystal molecules LM are influenced by the electric fields to change their orientation state. At the time of on, incident linearly polarized light, when passing through the liquid crystal layer LC, changes its polarized state in accordance with the orientation state of the liquid crystal molecules LM.

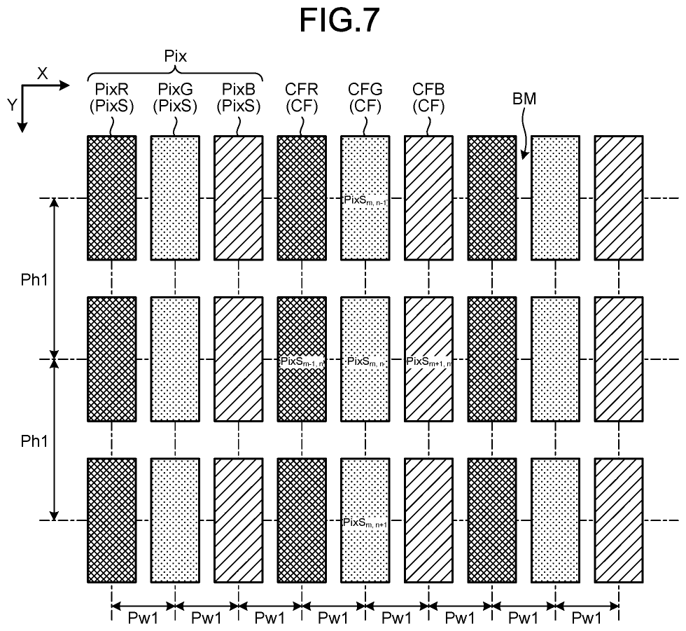

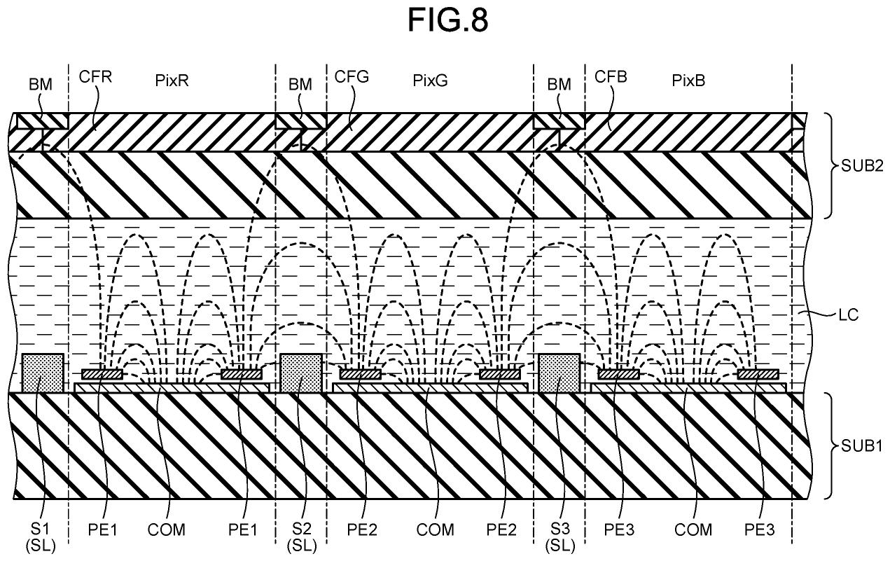

FIG. 7 is a diagram of an example of a pixel arrangement according to the first embodiment. FIG. 8 is a schematic sectional view of the display panel for illustrating influence by mutual electric lines of force between pixels adjacent to each other. In FIG. 7, a distance between the pixels PixS (the pixels PixR, PixG, and PixB) in the Y direction is defined as Phi, whereas the distance in the X direction is defined as Pw1. FIG. 8 illustrates only the components necessary for the description in the present disclosure, with the other components omitted or simplified.

As illustrated in FIG. 7, in the display panel 110 according to the present embodiment, the color filters CF (CFR, CFG, and CFB) of the pixels PixS (the pixels PixR, PixG, and PixB) are sectioned by the light shielding layer BM. The pixels PixS (the pixels PixR, PixG, and PixB) cause light emitted from the backlight unit IL to pass through openings in which the color filters CF (CFR, CFG, and CFB) are provided to emit the colors (blue, red, and green).

When a pixel voltage is applied to the pixel electrodes PE1, PE2, and PE3 to cause a potential difference between the pixel electrodes PE1, PE2, and PE3 and the common electrode COM, the pixels PixS cause electric fields having electric lines of force emerging from the surface of the pixel electrodes PE1, PE2, and PE3 to reach the surface of the common electrode COM as indicated by the broken lines in FIG. 8.

As the pixel density of the display region 111 becomes higher, influence by the mutual electric lines of force becomes larger between the pixels PixS illustrated in FIG. 8. Thus, there is a possibility that the mutual electric lines of force exert influence on each other between the pixels PixS to cause color shift and a reduction in the accuracy of displayed colors.

Specifically, for example, in a case in which the pixel density of the display region 111 is 538 ppi (the distance Phi between the pixels PixS in the Y direction is 47.25 μm, whereas the distance Pw1 between the pixels PixS in the X direction is 15.75 μm) and a case in which the pixel density of the display region 111 is 806 ppi (the distance Phi between the pixels PixS in the Y direction is 31.5 μm, whereas the distance Pw1 between the pixels PixS in the X direction is 10.5 μm), the color shift caused by the fact that the electric lines of force between the pixels PixS exert influence on each other occurs more conspicuously in the case in which the pixel density of the display region 111 is 806 ppi.

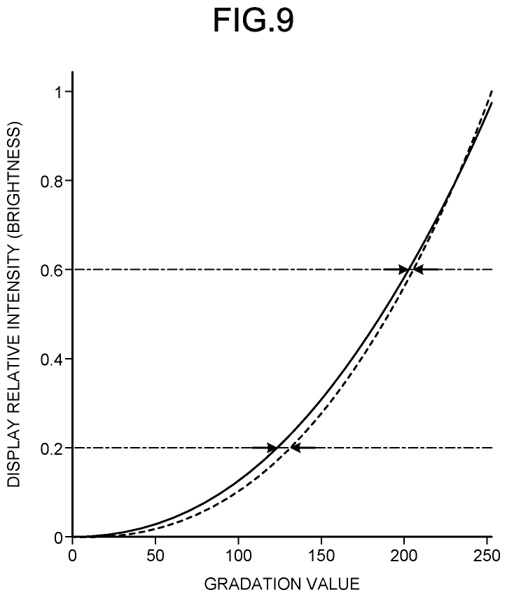

FIG. 9 is a diagram of display relative intensity in the case of white display and monochromatic display of a pixel of each color. In FIG. 9, the vertical axis indicates a value with the maximum brightness of the pixels PixS normalized as 1, whereas the horizontal axis indicates a gradation value of pixel signals supplied to the pixels PixS. FIG. 9 exemplifies a case in which the pixel signals supplied to the pixels PixS are each represented by an 8-bit value (a value with “0” as the minimum value and “255” as the maximum value).

As illustrated in FIG. 9, the gradation value giving similar display relative intensity is different between the white display and the monochromatic display of the pixels PixS of each color. In a range in which the display relative intensity is low, that is, when relatively dark display is performed, the shift of the gradation value giving similar display relative intensity between the white display and the monochromatic display of the pixels PixS of each color is large, for example. Specifically, as illustrated in FIG. 9, the shift of the gradation value when the monochromatic display of the pixels PixS of each color with respect to the gradation value when the white display is performed is larger when the display relative intensity is “0.2” than when the display relative intensity is “0.6”. The magnitude of the shift of the gradation value between the white display and the monochromatic display giving similar display relative intensity varies by the degree of influence of the electric lines of force between the pixels PixS such as the pixel density of the display region 111, the width of the pixels PixS in the X direction, the width of the pixels PixS in the Y direction, the distance Pw1 between the pixels PixS in the X direction, and the distance Phi between the pixels PixS in the Y direction.

In the present disclosure, the gradation value varying by the degree of influence of the electric lines of force between the pixels PixS is corrected. Correction of the gradation value is preferably performed such that the pixels PixR, PixG, and PixB have the same relative intensity with respect to respective gradations given to them even with any combination of the respective gradations of the pixels PixR, PixG, and PixB. In the present disclosure, as an example, based on the display of white (that is, the intensity of the pixel PixR=the intensity of the pixel PixG=the intensity of the pixel PixB), for general display in which any one or more of the intensities of the pixels PixR, PixG, and PixB do not match, shift from the relative intensity of the pixels PixR, PixG, and PixB in the white display is corrected.

The following first describes the necessity of pixel gradation correction in the first example of the pixel configuration illustrated in FIG. 7. In FIG. 7, a pixel PixS_{m,n} present on the mth row and the nth column is a pixel for which the pixel gradation will be corrected. In the first example of the pixel configuration illustrated in FIG. 7, the width in the X direction, the width in the Y direction, the distance Pw1 in the X direction, and the distance Phi in the Y direction of the pixels PixS of the respective colors (the pixels PixR, PixG, and PixB) are each the same value.

In the first example of the pixel configuration illustrated in FIG. 7, the distance Phi between the pixels PixS (the pixels PixR, PixG, and PixB) in the Y direction is larger than the distance Pw1 between the pixels PixS (the pixels PixR, PixG, and PixB) in the X direction. In such a pixel arrangement, influence by the electric lines of force of a pixel PixS_{m,n-1} and a pixel PixS_{m,n+1}, which are adjacent to the pixel PixS_{m,n} for which the pixel gradation will be corrected in the Y direction, is smaller than influence by the electric lines of force of a pixel PixS_{m-1,n} and a pixel PixS_{m+1,n}, which are adjacent to the pixel PixS_{m,n} in the X direction.

Specifically, as taken as an example in which the color shift caused by the fact that the electric lines of force between the pixels PixS exert influence on each other conspicuously occurs in the above, when the pixel density of the display region 111 is 806 ppi, the influence by the electric lines of force of the pixel PixS_{m-1,n} and the pixel PixS_{m+1,n}, which are adjacent to the pixel PixS_{m,n} for which the pixel gradation will be corrected with 10.5 μm (=Pw1) in the X direction, is conspicuous, whereas the influence by the electric lines of force of the pixel PixS_{m,n-1} and the pixel PixS_{m,n+1}, which are adjacent to the pixel PixS_{m,n} for which the pixel gradation will be corrected with 31.5 μm (=Phi) in the Y direction, is extremely small. That is to say, in the first example of the pixel configuration illustrated in FIG. 7, the influence by the electric lines of force of the pixel PixS_{m,n-1} and the pixel PixS_{m,n+1}, which are adjacent to the pixel PixS_{m,n} for which the pixel gradation will be corrected in the Y direction, is not necessarily required to be considered.

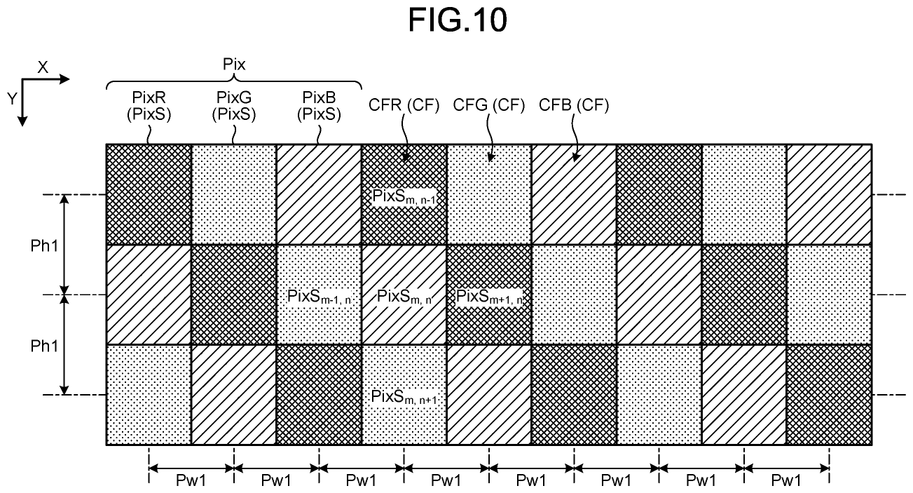

FIG. 10 is a diagram of a second example of the pixel arrangement according to the first embodiment. In the second example of the pixel arrangement illustrated in FIG. 10, the difference between the distance Phi between the pixels PixS (the pixels PixR, PixG, and PixB) in the Y direction and the distance Pw1 between the pixels PixS (the pixels PixR, PixG, and PixB) in the X direction is smaller than that of the first example of the pixel configuration illustrated in FIG. 7. In such a pixel arrangement, in addition to the influence by the electric lines of force of the pixel PixS_{m-1,n} and the pixel PixS_{m+1,n}, which are adjacent to the pixel PixS_{m,n} for which the pixel gradation will be corrected in the X direction, the influence by the electric lines of force of the pixel PixS_{m,n-1} and the pixel PixS_{m,n+1}, which are adjacent to the pixel PixS_{m,n} in the Y direction, is required to be considered. Specifically, the pixel density in the second example of the pixel arrangement illustrated in FIG. 10 assumes 2,000 ppi or more, for example. In such a high-definition panel, pixel gradation correction considering the influence by the electric lines of force of the pixels adjacent to the pixel PixS_{m,n} for which the pixel gradation will be corrected in the X direction and the Y direction is preferably performed.

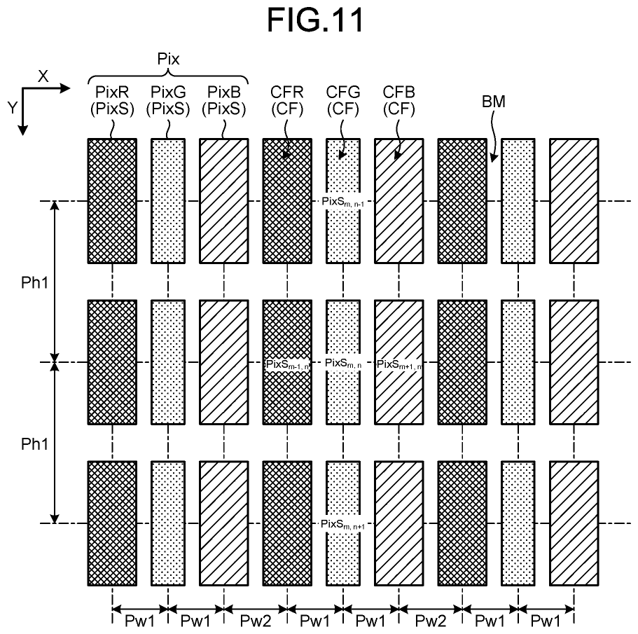

FIG. 11 is a diagram of a third example of the pixel arrangement according to the first embodiment. In the third example of the pixel configuration illustrated in FIG. 11, the width of a specific pixel PixS (the pixel PixG, for example) in the X direction is smaller than those of the other pixels PixS (the pixels PixR and PixB, for example). In such a pixel arrangement, the pixels PixS having a larger width in the X direction (the pixels PixR and PixB, for example) may be excluded from the pixel for which the pixel gradation will be corrected.

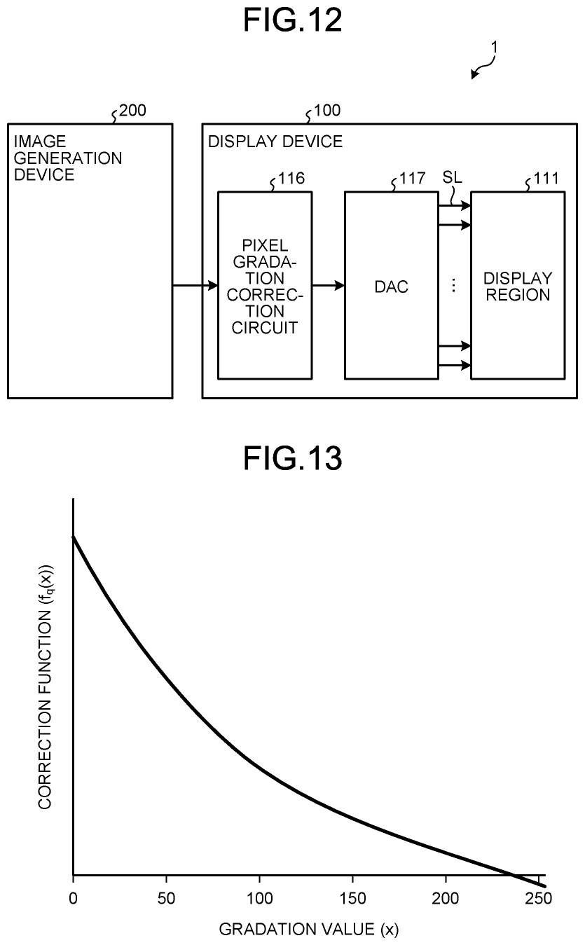

FIG. 12 is a block diagram of a pixel gradation correction circuit according to the first embodiment. As illustrated in FIG. 12, in the present embodiment, the display device 100 is provided with a pixel gradation correction circuit 116. The pixel gradation correction circuit 116 is provided in the driver IC 115 illustrated in FIG. 3, for example. In the present disclosure, the pixel gradation correction circuit 116 corresponds to a “pixel gradation corrector”.

Output of the pixel gradation correction circuit 116 is DA converted by a DAC 117 to be output to the display region 111. The DAC 117 is provided in the driver IC 115 illustrated in FIG. 3, for example.

The component provided with the pixel gradation correction circuit 116 and the DAC 117 is not limited to the driver IC 115; a component different from the driver IC 115 may be provided with the pixel gradation correction circuit 116 and the DAC 117 or the pixel gradation correction circuit 116 and the DAC 117 may be included as independent components, for example. Image correction processing such as gamma correction and white balance correction is preferably performed before the pixel gradation correction circuit 116.

The pixel gradation correction circuit 116 performs pixel gradation correction processing for each of the pixels PixS using Expression (1) below and Expression (2) below.

Vo_{m,n}=Vi_{m,n}−f(Vi_{m,n})×{S_{L}(Vi_{m-1,n}−Vi_{m,n})+S_{R}(Vi_{m+1,n}−Vi_{m,n})+S_{U}(Vi_{m,n-1}−Vi_{m,n})+S_{D}(Vi_{m,n+1}−Vi_{m,n})} (1)

f(Vi_{m,n})=f_{q}(x)=A_{q}x³+C_{q}x²+D_{q}x+E_{q} (2)

In Expression (1), Vi_{m,n} indicates a pixel gradation input value (an input gradation value) to the pixel gradation correction circuit 116 for the pixel PixS_{m,n} for which the pixel gradation will be corrected. f(Vi_{m,n}) is a function indicating susceptibility with which the pixel PixS_{m,n} for which the pixel gradation will be corrected is influenced by adjacent pixels, that is, sensitivity with which the pixel PixS_{m,n} for which the pixel gradation will be corrected is influenced by the adjacent pixels. Vo_{m,n} indicates an output value (an output gradation value) of the pixel gradation correction circuit 116 having corrected the input gradation value Vi_{m,n} for the pixel PixS_{m,n} for which the pixel gradation will be corrected, that is, a corrected gradation value as a gradation value to be output to the pixel PixS_{m,n} for which the pixel gradation will be corrected.

That is to say, a correction amount for the pixel PixS_{m,n} for which the pixel gradation will be corrected can be represented by the product of the following two terms. The first is a “value indicating sensitivity influenced by the adjacent pixels (the term f(Vi_{m,n}) indicated in Expression (1)”, which changes the value in accordance with the input gradation value Vi_{m,n} that the pixel PixS_{m,n} for which the pixel gradation will be corrected should originally display. The second is a product of the difference between the input gradation value Vi_{m,n} that the pixel PixS_{m,n} for which the pixel gradation will be corrected should originally display and an input gradation value that a pixel adjacent to the pixel should originally display and a certain coefficient, that is, a “value indicating the strength of influence that the adjacent pixels exert on the pixel PixS_{m,n} for which the pixel gradation will be corrected (the term {S_{L}(Vi_{m-1,n}−Vi_{m,n})+S_{R}(Vn_{m+1,n}−Vi_{m,n})+S_{U}(Vi_{m,n-1}−Vi_{m,n})+S_{D}(Vi_{m,n+1}−Vi_{m,n})} indicated in Expression (1))”. The product of the “value indicating sensitivity influenced by the adjacent pixels” and the “value indicating the strength of influence that the adjacent pixels exert on the pixel PixS_{m,n} for which the pixel gradation will be corrected” is subtracted from the input gradation value Vi_{m,n} that the pixel PixS_{m,n} for which the pixel gradation will be corrected should originally display. An output gradation value Vo_{m,n} (refer to Expression (1)) having been obtained as a result of this is given to the pixel PixS_{m,n} for which the pixel gradation will be corrected. Thus, display intensity that should originally be displayed in the pixel PixS_{m,n} for which the pixel gradation will be corrected is obtained. The following describes coefficients for calculating the “value indicating the strength of influence that the adjacent pixels exert on the pixel PixS_{m,n} for which the pixel gradation will be corrected” (hereinafter may be referred to simply as “coefficients indicating the strength of influence that the adjacent pixels exert”).

S_{L} is a coefficient indicating the strength of influence that the pixel PixS_{m-1,n} adjacent to the pixel PixS_{m,n} for which the pixel gradation will be corrected on the left side in the X direction exerts on the pixel PixS_{m,n}. S_{R} is a coefficient indicating the strength of influence that the pixel PixS_{m+1,n} adjacent to the pixel PixS_{m,n} for which the pixel gradation will be corrected on the right side in the X direction exerts on the pixel PixS_{m,n}. S_{U} is a coefficient indicating the strength of influence that the pixel PixS_{m,n-1} adjacent to the pixel PixS_{m,n} for which the pixel gradation will be corrected on the upper side in the Y direction exerts on the pixel PixS_{m,n}. S_{D} is a coefficient indicating the strength of influence that the pixel PixS_{m,n+1} adjacent to the pixel PixS_{m,n} for which the pixel gradation will be corrected on the down side in the Y direction exerts on the pixel PixS_{m,n}. These coefficients S_{L}, S_{R}, S_{U}, and S_{D} are set in advance in accordance with the pixel arrangement of the display region 111, the shape and orientation of the pixel electrodes PE of the pixels PixS (the pixels PixR, PixG, and PixB), and the like.

Vi_{m-1,n} indicates an input gradation value, that is, an input value before pixel gradation correction to the pixel gradation correction circuit 116 for the pixel PixS_{m-1,n} adjacent to the pixel PixS_{m,n} for which the pixel gradation will be corrected on the left side in the X direction. Vi_{m+1,n} indicates an input gradation value, that is, an input value before pixel gradation correction to the pixel gradation correction circuit 116 for the pixel PixS_{m+1,n} adjacent to the pixel PixS_{m,n} for which the pixel gradation will be corrected on the right side in the X direction. Vi_{m,n-1} indicates an input gradation value, that is, an input value before pixel gradation correction to the pixel gradation correction circuit 116 for the pixel PixS_{m,n-1} adjacent to the pixel PixS_{m,n} for which the pixel gradation will be corrected on the upper side in the Y direction. Vi_{m,n+1} indicates an input gradation value, that is, an input value before pixel gradation correction to the pixel gradation correction circuit 116 for the pixel PixS_{m,n+1} adjacent to the pixel PixS_{m,n} for which the pixel gradation will be corrected on the down side in the Y direction.

In Expression (2), f_{q}(x) is a function indicating the sensitivity with which the pixel PixS_{m,n} for which the pixel gradation will be corrected is influenced by the adjacent pixels. The function f_{q}(x) in Expression (2) is the same as the function f(Vi_{m,n}) indicated in Expression (1). In Expression (2), x indicates an input gradation value, that is, an input value before pixel gradation correction to the pixel gradation correction circuit 116 for the pixel PixS_{m,n} for which the pixel gradation will be corrected. The input gradation value x in Expression (2) is the same as the input gradation value Vi_{m,n} in Expression (1). A_{q}, C_{q}, D_{q}, and E_{q} indicate coefficients set in advance in accordance with the sensitivity with which the pixel PixS_{m,n} for which the pixel gradation will be corrected is influenced by the adjacent pixels.

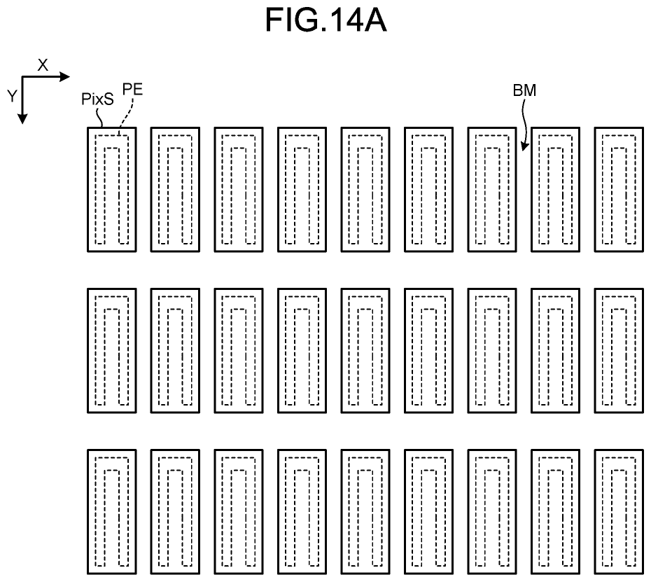

FIG. 13 is a diagram of an example of a function indicating the sensitivity with which the pixel for which the pixel gradation will be corrected is influenced by the adjacent pixels. In FIG. 13, the horizontal axis indicates the input value x of the pixel gradation for the pixel PixS_{m,n} for which the pixel gradation will be corrected, whereas the vertical axis indicates the value of the function f_{q}(x) indicating the sensitivity with which the pixel PixS_{m,n} for which the pixel gradation will be corrected is influenced by the adjacent pixels.

As illustrated in FIG. 13, the function f_{q}(x) indicating the sensitivity with which the pixel PixS_{m,n} for which the pixel gradation will be corrected is influenced by the adjacent pixels (hereinafter also referred to simply as the “function f_{q}(x)”) is a value varying by the magnitude of the input gradation value x to the pixel gradation correction circuit 116 (hereinafter also referred to simply as the “input gradation value x”) for the pixel PixS_{m,n} for which the pixel gradation will be corrected. Specifically, the function f_{q}(x) is a value corresponding to the magnitude of the shift of the gradation value giving similar display relative intensity in the display relative intensity in the case of the white display and the monochromatic display of the pixels PixS of each color illustrated in FIG. 9. As illustrated in FIG. 9, in the range in which the display relative intensity is low, that is, in a range in which the input gradation value x for the pixel PixS_{m,n} for which the pixel gradation will be corrected is small, the value of the function f_{q}(x) is large, for example.

Pixel gradation correction processing for each of the pixels PixS is performed by Expression (1) and Expression (2) using the function f_{q}(x) determined in advance as described above, whereby the shift of the gradation values of the pixels PixS (the pixels PixR, PixG, and PixB) with respect to the gradation values when the white display is performed can be corrected. More correctly, with display intensity (three stimulus values) in the case of the white display (that is, the gradation values of the pixels PixR, PixG, and PixB of an image to be displayed all match) as being correct, in the case of not being the white display (that is, there is any gradation that does not match in the gradation values of the pixels PixR, PixG, and PixB of an image to be displayed), the display intensities of the pixels PixR, PixG, and PixB can be compensated so as to be intensities expected as image display to be displayed. The following describes pixel gradation correction expressions in the pixels PixR, PixG, and PixB.

In the first example of the pixel configuration illustrated in FIG. 7, when the pixel PixS_{m,n} for which the pixel gradation will be corrected is the pixel PixR, when an input gradation value of a pixel PixR_{m,n} is Ri_{m,n}(=x), a function indicating sensitivity with which the pixel PixR_{m,n} is influenced by adjacent pixels is f(Ri_{m,n}) (=f_{R}(x)), an input gradation value for a pixel PixB_{m-1,n}, which is adjacent to the pixel PixR_{m,n} on the left side in the X direction, is Bi_{m-1,n}, an input gradation value for a pixel PixG_{m+1,n}, which is adjacent to the pixel PixR_{m,n} on the right side in the X direction, is Gi_{m+1,n}, an input gradation value for a pixel PixR_{m,n-1}, which is adjacent to the pixel PixR_{m,n} on the upper side in the Y direction, is Ri_{m,n-1}, an input gradation value for a pixel PixR_{m,n+1}, which is adjacent to the pixel PixR_{m,n} on the down side in the Y direction, is Ri_{m,n+1}, a coefficient indicating the strength of influence that the pixel PixB_{m-1,n}, which is adjacent to the pixel PixR_{m,n} on the left side in the X direction, exerts is SR_{L}, a coefficient indicating the strength of influence that the pixel PixG_{m+1,n}, which is adjacent to the pixel PixR_{m,n} on the right side in the X direction, exerts is SR_{R}, a coefficient indicating the strength of influence that the pixel PixR_{m,n-1}, which is adjacent to the pixel PixR_{m,n} on the upper side in the Y direction, exerts is SR_{U}, a coefficient indicating the strength of influence that the pixel PixR_{m,n+1}, which is adjacent to the pixel PixR_{m,n} on the down side in the Y direction, exerts is SRD, and coefficients set in accordance with the sensitivity with which the pixel PixR_{m,n} is influenced by the adjacent pixels are A_{R}, C_{R}, D_{R}, and E_{R}, a corrected gradation value for the pixel PixR_{m,n}, that is, an output gradation value Ro_{m,n} as an output value of the pixel gradation correction circuit 116 is indicated by Expression (3) below and Expression (4) below.

Ro_{m,n}=Ri_{m,n}−f(Ri_{m,n})×{SR_{L}(Bi_{m-1,n}−Ri_{m,n})+SR_{R}(Gi_{m+1,n}−Ri_{m,n})+SR_{U}(Ri_{m,n-1}−Ri_{m,n})+SR_{D}(Ri_{m,n+1}−Ri_{m,n})} (3)

f(Ri_{m,n})=f_{R}(x)=A_{R}x³+C_{R}x²+D_{R}x+E_{R} (4)

In the first example of the pixel configuration illustrated in FIG. 7, when the pixel PixS_{m,n} for which the pixel gradation will be corrected is the pixel PixG, when an input gradation value of a pixel PixG_{m,n} is Gi_{m,n}(=x), a function indicating sensitivity with which the pixel PixG_{m,n} is influenced by adjacent pixels is f(Gi_{m,n}) (=f_{G}(x)), an input gradation value for a pixel PixB_{m-1,n}, which is adjacent to the pixel PixG_{m,n} on the left side in the X direction, is Bi_{m-1,n}, an input gradation value for a pixel PixR_{m+1,n}, which is adjacent to the pixel PixR_{m,n} on the right side in the X direction, is Ri_{m+1,n}, an input gradation value for a pixel PixG_{m,n-1}, which is adjacent to the pixel PixG_{m,n} on the upper side in the Y direction, is Gi_{m,n-1}, an input gradation value for a pixel PixG_{m,n+1}, which is adjacent to the pixel PixG_{m,n} on the down side in the Y direction, is Gi_{m,n+1}, a coefficient indicating the strength of influence that the pixel PixB_{m-1,n}, which is adjacent to the pixel PixG_{m,n} on the left side in the X direction, exerts is SG_{L}, a coefficient indicating the strength of influence that the pixel PixR_{m+1,n}, which is adjacent to the pixel PixR_{m,n} on the right side in the X direction, exerts is SG_{R}, a coefficient indicating the strength of influence that the pixel PixG_{m,n-1}, which is adjacent to the pixel PixG_{m,n} on the upper side in the Y direction, exerts is SG_{U}, a coefficient indicating the strength of influence that the pixel PixG_{m,n+1}, which is adjacent to the pixel PixG_{m,n} on the down side in the Y direction, exerts is SG_{D}, and coefficients set in accordance with the sensitivity with which the pixel PixG_{m,n} is influenced by the adjacent pixels are A_{G}, C_{G}, D_{G}, and E_{G}, a corrected gradation value for the pixel PixG_{m,n}, that is, an output gradation value Go_{m,n} as an output value of the pixel gradation correction circuit 116 is indicated by Expression (5) below and Expression (6) below.

Go_{m,n}=Gi_{m,n}−f(Gi_{m,n})×{SG_{L}(Ri_{m-1,n}−Gi_{m,n})+SG_{R}(Bi_{m+1,n}−Gi_{m,n})+SG_{U}(Gi_{m,n-1}−Gi_{m,n})+SG_{D}(Gi_{m,n+1}−Gi_{m,n})} (5)

f(Gi_{m,n})=f_{G}(x)=A_{G}x³+C_{G}x²+D_{G}x+E_{G} (6)

In the first example of the pixel configuration illustrated in FIG. 7, when the pixel PixS_{m,n} for which the pixel gradation will be corrected is the pixel PixB, when an input gradation value of a pixel PixB_{m,n} is Bi_{m,n}(=x), a function indicating sensitivity with which the pixel PixB_{m,n} is influenced by adjacent pixels is f(Bi_{m,n}) (=f_{B}((x)), an input gradation value for a pixel PixG_{m-1,n}, which is adjacent to the pixel PixB_{m,n} on the left side in the X direction, is Gi_{m-1,n}, an input gradation value for a pixel PixR_{m+1,n}, which is adjacent to the pixel PixB_{m,n} on the right side in the X direction, is Ri_{m+1,n}, an input gradation value for a pixel PixB_{m,n-1}, which is adjacent to the pixel PixB_{m,n} on the upper side in the Y direction, is Bi_{m,n-1}, an input gradation value for a pixel PixB_{m,n+1}, which is adjacent to the pixel PixB_{m,n} on the down side in the Y direction, is Bi_{m,n+1}, a coefficient indicating the strength of influence that the pixel PixG_{m-1,n}, which is adjacent to the pixel PixB_{m,n} on the left side in the X direction, exerts is SB_{L}, a coefficient indicating the strength of influence that the pixel PixR_{m+1,n}, which is adjacent to the pixel PixB_{m,n} on the right side in the X direction, exerts is SB_{R}, a coefficient indicating the strength of influence that the pixel PixB_{m,n-1}, which is adjacent to the pixel PixB_{m,n} on the upper side in the Y direction, exerts is SB_{U}, a coefficient indicating the strength of influence that the pixel PixB_{m,n+1}, which is adjacent to the pixel PixB_{m,n} on the down side in the Y direction, exerts is SBD, and coefficients set in accordance with the sensitivity with which the pixel PixB_{m,n} is influenced by the adjacent pixels are A_{B}, C_{B}, D_{B}, and E_{B}, a corrected gradation value for the pixel PixB_{m,n}, that is, an output gradation value Bo_{m,n} as an output value of the pixel gradation correction circuit 116 is indicated by Expression (7) below and Expression (8) below.

Bo_{m,n}=Bi_{m,n}−f(Bi_{m,n})×{SB_{L}(Gi_{m-1,n}−Bi_{m,n})+SB_{R}(Ri_{m+1,n}−Bi_{m,n})+SB_{U}(Bi_{m,n-1}−Bi_{m,n})+SB_{D}(Bi_{m,n+1}−Bi_{m,n})} (7)

f(Bi_{m,n})=f_{B}(x)=A_{B}x³+C_{B}x²+D_{B}x+E_{B} (8)

As described in the first example of the pixel configuration illustrated in FIG. 7, when there is no need to consider the influence by the electric lines of force of the pixel PixS_{m,n-1} and the pixel PixS_{m,n+1}, which are adjacent to the pixel PixS_{m,n} for which the pixel gradation will be corrected in the Y direction, Expression (1), Expression (3), Expression (5), and Expression (7) are indicated by Expression (10) below, Expression (11) below, Expression (12) below, and Expression (13) below, respectively.

Vo_{m,n}=Vi_{m,n}−f(Vi_{m,n})×{S_{L}(Vi_{m-1,n}−Vi_{m,n})+S_{R}(Vi_{m+1,n}−Vi_{m,n})} (10)

Ro_{m,n}=Ri_{m,n}−f(Ri_{m,n})×{SR_{L}(Bi_{m-1,n}−Ri_{m,n})+SR_{R}(Gi_{m+1,n}−Ri_{m,n})} (11)

Go_{m,n}=Gi_{m,n}−f(Gi_{m,n})×{SG_{L}(Ri_{m-1,n}−Gi_{m,n})+SG_{R}(Bi_{m+1,n}−Gi_{m,n})} (12)

Bo_{m,n}=Bi_{m,n}−f(Bi_{m,n})×{SB_{L}(Gi_{m-1,n}−Bi_{m,n})+SB_{R}(Ri_{m+1,n}−Bi_{m,n})} (13)

As described in the third example of the pixel configuration illustrated in FIG. 11, when the pixels PixS having a larger width in the X direction (the pixels PixR and PixB, for example) may be excluded from the pixel for which the pixel gradation will be corrected, the coefficients SR_{L} and SR_{R} indicating the strength of influence that the adjacent pixels of the pixel PixR_{m,n} for which the pixel gradation will be corrected exert and the coefficients SB_{L} and SB_{R} indicating the strength of influence that the adjacent pixels of the pixel PixB_{m,n} for which the pixel gradation will be corrected exert are all made “0”, whereby Expression (3) and Expression (7) are indicated by Expression (14) below and Expression (15) below, respectively.

Ro_{m,n}=Ri_{m,n} (14)

Bo_{m,n}=Bi_{m,n} (15)

In the second example of the pixel configuration illustrated in FIG. 10, when the pixel PixS_{m,n} for which the pixel gradation will be corrected is the pixel PixR, when an input gradation value of a pixel PixR_{m,n} is Ri_{m,n}(=x), a function indicating sensitivity with which the pixel PixR_{m,n} is influenced by adjacent pixels is f(Ri_{m,n}) (=f_{R}(x)), an input gradation value for a pixel PixB_{m,n}, which is adjacent to the pixel PixR_{m,n} on the left side in the X direction, is Bi_{m-1,n}, an input gradation value for a pixel PixG_{m+1,n}, which is adjacent to the pixel PixR_{m,n} on the right side in the X direction, is Gi_{m+1,n}, an input gradation value for a pixel PixG_{m,n-1}, which is adjacent to the pixel PixR_{m,n} on the upper side in the Y direction, is Gi_{m,n-1}, an input gradation value for a pixel PixB_{m,n+1}, which is adjacent to the pixel PixR_{m,n} on the down side in the Y direction, is Bi_{m,n+1}, a coefficient indicating the strength of influence that the pixel PixB_{m-1,n}, which is adjacent to the pixel PixR_{m,n} on the left side in the X direction, exerts is SR_{L}, a coefficient indicating the strength of influence that the pixel PixG_{m+1,n}, which is adjacent to the pixel PixR_{m,n} on the right side in the X direction, exerts is SR_{R}, a coefficient indicating the strength of influence that the pixel PixG_{m,n-1}, which is adjacent to the pixel PixR_{m,n} on the upper side in the Y direction, exerts is SR_{U}, a coefficient indicating the strength of influence that the pixel PixB_{m,n+1}, which is adjacent to the pixel PixR_{m,n} on the down side in the Y direction, exerts is SR_{D}, and coefficients set in accordance with the sensitivity with which the pixel PixR_{m,n} is influenced by the adjacent pixels are A_{R}, C_{R}, D_{R}, and E_{R}, a corrected gradation value for the pixel PixR_{m,n}, that is, an output gradation value Ro_{m,n} as an output value of the pixel gradation correction circuit 116 is indicated by Expression (16) below and Expression (17) below.

Ro_{m,n}=Ri_{m,n}−f(Ri_{m,n})×{SR_{L}(Bi_{m-1,n}−Ri_{m,n})+SR_{R}(Gi_{m+1,n}−Ri_{m,n})+SR_{U}(Gi_{m,n-1}−Ri_{m,n})+SR_{D}(Bi_{m,n+1}−Ri_{m,n})} (16)

f(Ri_{m,n})=f_{R}(x)=A_{R}x³+C_{R}x²+D_{R}x+E_{R} (17)

In the second example of the pixel configuration illustrated in FIG. 10, when the pixel PixS_{m,n} for which the pixel gradation will be corrected is the pixel PixG, when an input gradation value of a pixel PixG_{m,n} is Gi_{m,n}(=x), a function indicating sensitivity with which the pixel PixG_{m,n} is influenced by adjacent pixels is f(Gi_{m,n}) (=f_{G}(x)), an input gradation value for a pixel PixB_{m-1,n}, which is adjacent to the pixel PixG_{m,n} on the left side in the X direction, is Bi_{m-1,n}, an input gradation value for a pixel PixR_{m+1,n}, which is adjacent to the pixel PixR_{m,n} on the right side in the X direction, is Ri_{m+1,n}, an input gradation value for a pixel PixB_{m,n-1}, which is adjacent to the pixel PixG_{m,n} on the upper side in the Y direction, is Bi_{m,n-1}, an input gradation value for a pixel PixR_{m,n+1}, which is adjacent to the pixel PixG_{m,n} on the down side in the Y direction, is Ri_{m,n+1}, a coefficient indicating the strength of influence that the pixel PixB_{m-1,n}, which is adjacent to the pixel PixG_{m,n} on the left side in the X direction, exerts is SG_{L}, a coefficient indicating the strength of influence that the pixel PixR_{m+1,n}, which is adjacent to the pixel PixR_{m,n} on the right side in the X direction, exerts is SG_{R}, a coefficient indicating the strength of influence that the pixel PixB_{m,n-1}, which is adjacent to the pixel PixG_{m,n} on the upper side in the Y direction, exerts is SG_{U}, a coefficient indicating the strength of influence that the pixel PixR_{m,n+1}, which is adjacent to the pixel PixG_{m,n} on the down side in the Y direction, exerts is SG_{D}, and coefficients set in accordance with the sensitivity with which the pixel PixG_{m,n} is influenced by the adjacent pixels are A_{G}, C_{G}, D_{G}, and E_{G}, a corrected gradation value for the pixel PixG_{m,n}, that is, an output gradation value Go_{m,n} as an output value of the pixel gradation correction circuit 116 is indicated by Expression (18) below and Expression (19) below.

Go_{m,n}=Gi_{m,n}−f(Gi_{m,n})×{SG_{L}(Ri_{m-1,n}−Gi_{m,n})+SG_{R}(Bi_{m+1,n}−Gi_{m,n})+SG_{U}(Bi_{m,n-1}−Gi_{m,n})+SG_{D}(Ri_{m,n+1}−Gi_{m,n})} (18)

f(Gi_{m,n})=f_{G}(x)=A_{G}x³+C_{G}x²+D_{G}x+E_{G} (19)

In the second example of the pixel configuration illustrated in FIG. 10, when the pixel PixS_{m,n} for which the pixel gradation will be corrected is the pixel PixB, when an input gradation value of a pixel PixB_{m,n} is Bi_{m,n}(=x), a function indicating sensitivity with which the pixel PixB_{m,n} is influenced by adjacent pixels is f(Bi_{m,n}) (=f_{B}((x)), an input gradation value for a pixel PixG_{m-1,n}, which is adjacent to the pixel PixB_{m,n} on the left side in the X direction, is Gi_{m-1,n}, an input gradation value for a pixel PixR_{m+1,n}, which is adjacent to the pixel PixB_{m,n} on the right side in the X direction, is Ri_{m+1,n}, an input gradation value for a pixel PixR_{m,n-1}, which is adjacent to the pixel PixB_{m,n} on the upper side in the Y direction, is Ri_{m,n-1}, an input gradation value for a pixel PixG_{m,n+1}, which is adjacent to the pixel PixB_{m,n} on the down side in the Y direction, is Gi_{m,n+1}, a coefficient indicating the strength of influence that the pixel PixG_{m-1,n}, which is adjacent to the pixel PixB_{m,n} on the left side in the X direction, exerts is SB_{L}, a coefficient indicating the strength of influence that the pixel PixR_{m+1,n}, which is adjacent to the pixel PixB_{m,n} on the right side in the X direction, exerts is SB_{R}, a coefficient indicating the strength of influence that the pixel PixR_{m,n-1}, which is adjacent to the pixel PixB_{m,n} on the upper side in the Y direction, exerts is SB_{U}, a coefficient indicating the strength of influence that the pixel PixG_{m,n+1}, which is adjacent to the pixel PixB_{m,n} on the down side in the Y direction, exerts is SB_{D}, and coefficients set in accordance with the sensitivity with which the pixel PixB_{m,n} is influenced by the adjacent pixels are A_{B}, C_{B}, D_{B}, and E_{B}, a corrected gradation value for the pixel PixB_{m,n}, that is, an output gradation value Bo_{m,n} as an output value of the pixel gradation correction circuit 116 is indicated by Expression (20) below and Expression (21) below.

Bo_{m,n}=Bi_{m,n}−f(Bi_{m,n})×{SB_{L}(Gi_{m-1,n}−Bi_{m,n})+SB_{R}(Ri_{m+1,n}−Bi_{m,n})+SB_{U}(Ri_{m,n-1}−Bi_{m,n})+SB_{D}(Gi_{m,n+1}−Bi_{m,n})} (20)

f(Bi_{m,n})=f_{B}(x)=A_{B}x³+C_{B}x²+D_{B}x+E_{B} (21)

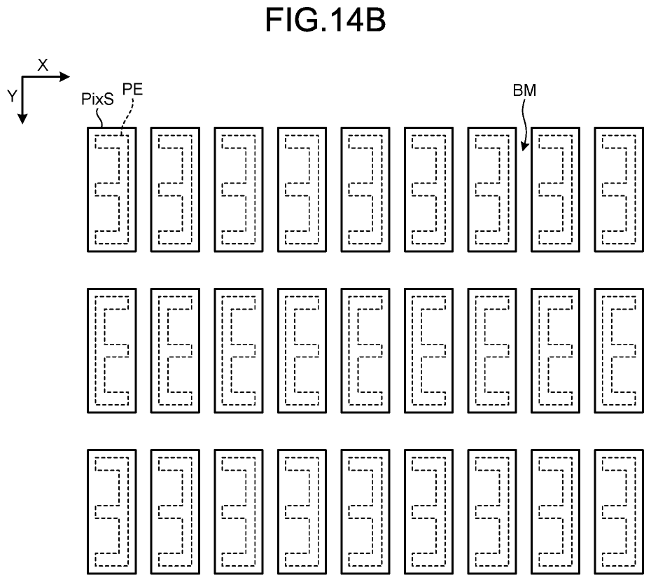

FIG. 14A is a diagram of an example of the shape of pixel electrodes in the first example of the pixel arrangement illustrated in FIG. 7. FIG. 14B is a diagram of an example in which the shape of the pixel electrodes is different between an odd row and an even row in the first example of the pixel arrangement illustrated in FIG. 7. FIG. 14B illustrates an example in which the orientation of the pixel electrodes PE indicated by the broken lines is inverted in the X direction between the odd row and the even row.

As illustrated in FIG. 14B, when the shape of the pixel electrodes PE of the pixels PixS (the pixels PixR, PixG, and PixB) is different between the pixels PixS (the pixels PixR, PixG, and PixB) on the odd row and the pixels PixS (the pixels PixR, PixG, and PixB) on the even row, in Expression (1), the values of the coefficients S_{L}, S_{R}, S_{U}, and S_{D} indicating the strength of influence that the pixels adjacent to the pixel PixS_{m,n} for which the pixel gradation will be corrected exert may each be different values between when the pixel PixS_{m,n} for which the pixel gradation will be corrected is present on the odd row and when the pixel PixS_{m,n} for which the pixel gradation will be corrected is on the odd row. When the coefficients when the pixel PixS_{m,n} for which the pixel gradation will be corrected is present on the odd row are S_{L1}, S_{R1}, S_{U1}, and S_{D1}, and when the coefficients when the pixel PixS_{m,n} for which the pixel gradation will be corrected is present on the even row are S_{L2}, S_{R2}, S_{U2}, and S_{D2}, a gradation value Vo1_{m,n} after gradation correction of the pixel PixS_{m,n} when the pixel PixS_{m,n} for which the pixel gradation will be corrected is present on the odd row and a gradation value Vo2_{m,n} after gradation correction of the pixel PixS_{m,n} when the pixel PixS_{m,n} for which the pixel gradation will be corrected is present on the even row are indicated by Expression (22) below and Expression (23), respectively.

Vo1_{m,n}=Vi_{m,n}−f(Vi_{m,n})×{S_{L1}(Vi_{m-1,n}−Vi_{m,n})+S_{R1}(Vi_{m+1,n}−Vi_{m,n})+S_{U1}(Vi_{m,n-1}−Vi_{m,n})+S_{D1}(Vi_{m,n+1}−Vi_{m,n})} (22)

Vo2_{m,n}=Vi_{m,n}−f(Vi_{m,n})×{S_{L2}(Vi_{m-1,n}−Vi_{m,n})+S_{R2}(Vi_{m+1,n}−Vi_{m,n})+S_{U2}(Vi_{m,n-1}−Vi_{m,n})+S_{D2}(Vi_{m,n+1}−Vi_{m,n})} (23)

In Expression (22) and Expression (23), when the orientation of the pixel electrodes PE is inverted in the X direction between the odd row and the even row as illustrated in FIG. 14B, for example, S_{L1} and S_{L2}, S_{R1} and S_{R2}, S_{U1} and S_{U2}, and S_{D1} and S_{D2} are indicated by values with inverted signs for each pair.

The following describes Expression (1) and Expression (2) in a generalized manner.

When the input gradation value of the pixel PixS_{m,n} for which the pixel gradation will be corrected (hereinafter referred to as a “first pixel”) is V1i, the function indicating the sensitivity with which the first pixel is influenced by the pixel PixS_{m-1,n}, the pixel PixS_{m+1,n}, the pixel PixS_{m,n-1}, and the pixel PixS_{m,n+1}, which are adjacent to the first pixel, (hereinafter referred to as “second pixels”) is f(V1i), the number of the second pixels adjacent to the first pixel is N, the input gradation value of the second pixels is V2i, and the coefficient indicating the strength of influence that the second pixels exert is Sp, Expression (1) can be indicated by Expression (24) below.

$$V 1 o = V 1 i - f ( V 1 i ) {\sum }_{p = 1}^{N} S p ( V 2 i - V 1 i ) \qquad ( 24 )$$

As to the function f(V1i) indicating the sensitivity with which the first pixel is influenced by the second pixels, when the input gradation value Vii of the first pixel is x, and the coefficients set in advance in accordance with the sensitivity with which the first pixel is influenced by the second pixels are A, C, D, and E, Expression (2) can be indicated by Expression (25) below.

f(V1i)=f(x)=Ax³+Cx²+Dx+E (25)

By the pixel gradation correction processing for each of the pixels PixS described in the present embodiment, the shift of the gradation values of the pixels PixS (the pixels PixR, PixG, and PixB) with respect to the gradation values when the white display is performed can be corrected. More correctly, with display intensity (three stimulus values) in the case of the white display (that is, the gradation values of the pixels PixR, PixG, and PixB of an image to be displayed all match) as being correct, in the case of not being the white display (that is, there is any gradation that does not match in the gradation values of the pixels PixR, PixG, and PixB of an image to be displayed), the display intensities of the pixels PixR, PixG, and PixB can be compensated so as to be intensities expected as image display to be displayed.

According to the present embodiment, the display device 100 and the display system 1 can inhibit a reduction in the accuracy of displayed colors along with higher definition.

### Second Embodiment

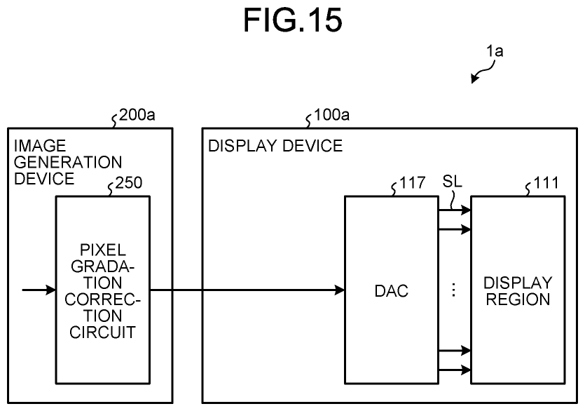

FIG. 15 is a block diagram of a pixel gradation correction circuit according to a second embodiment. For the components similar to or the same as those of the first embodiment described above, a duplicate description is omitted.

As illustrated in FIG. 15, in the present embodiment, an image generation device 200a is provided with a pixel gradation correction circuit 250. The pixel gradation correction circuit 250 is provided in the control circuit 230 illustrated in FIG. 3, for example. The component provided with the pixel gradation correction circuit 250 is not limited to the control circuit 230; a component different from the control circuit 230 may be provided with the pixel gradation correction circuit 250 or the pixel gradation correction circuit 250 may be included as an independent component, for example. In the present disclosure, the pixel gradation correction circuit 250 corresponds to the “pixel gradation corrector”.

Output of the pixel gradation correction circuit 250 is DA converted by the DAC 117 provided in a display device 100a to be output to the display region 111. The DAC 117 is provided in the driver IC 115 illustrated in FIG. 3, for example.

As illustrated in FIG. 15, in the configuration in which the image generation device 200a is provided with the pixel gradation correction circuit 250 as well, image correction processing such as gamma correction and white balance correction is preferably performed before the pixel gradation correction circuit 250 like the first embodiment.

According to the present embodiment, the display device 100a and a display system 1a can inhibit a reduction in the accuracy of displayed colors along with higher definition.

The preferred embodiments of the present disclosure have been described; the present disclosure is not limited to such embodiments. The details disclosed in the embodiments are only by way of example, and various modifications can be made in a range not departing from the gist of the present disclosure. Appropriate modifications made in the range not departing from the gist of the present disclosure also naturally belong to the technical scope of the present invention, for example.

What is claimed is:

1. A display device comprising:
a liquid crystal display panel having a display region;
pixels provided in the display region and arranged in a matrix (row-column configuration) in a first direction and a second direction different from the first direction; and
a pixel gradation corrector correcting a gradation value of a first pixel in accordance with gradation values of second pixels adjacent to the first pixel,
the pixel gradation corrector multiplying a value indicating sensitivity with which the first pixel is influenced by the second pixels and a value indicating strength of influence that the second pixels exert on the first pixel together, and subtracting the multiplied value from an input gradation value of the first pixel to calculate an output gradation value to the first pixel.

2. The display device according to claim 1, wherein the pixel gradation corrector calculates an output gradation value V1o to the first pixel using Expression (1) below when the input gradation value of the first pixel is V1i, a function indicating sensitivity with which the first pixel is influenced by the second pixels is f(V1i), number of the second pixels is N, an input gradation value of the second pixels is V2i, and a coefficient indicating strength of influence that the second pixels exert on the first pixel is Sp:
$$V 1 o = V 1 i - f ( V 1 i ) {\sum }_{p = 1}^{N} S p ( V 2 i - V 1 i ) \qquad ( 1 )$$

3. The display device according to claim 2, wherein the function f(V1i) is indicated by Expression (2) below when the input gradation value V1i of the first pixel is x, and coefficients set in advance in accordance with the sensitivity with which the first pixel is influenced by the second pixels are A, C, D, and E:
f(V1i)=f(x)=Ax³+Cx²+Dx+E (2)

4. The display device according to claim 1, wherein the pixels include a first pixel for displaying a first color, a second pixel for displaying a second color different from the first color, and a third pixel for displaying a third color, the third color being different from the first color and the second color.

5. A display system comprising:
a display device including
a liquid crystal display panel having a display region, and
pixels provided in the display region and arranged in a matrix (row-column configuration) in a first direction and a second direction different from the first direction; and
an image generation device including a pixel gradation corrector correcting a gradation value of a first pixel in accordance with gradation values of second pixels adjacent to the first pixel,
the pixel gradation corrector multiplying a value indicating sensitivity with which the first pixel is influenced by the second pixels and a value indicating strength of influence that the second pixels exert on the first pixel together, and subtracting the multiplied value from an input gradation value of the first pixel to calculate an output gradation value to the first pixel.

6. The display system according to claim 5, wherein the pixel gradation corrector calculates an output gradation value V1o to the first pixel using Expression (3) below when the input gradation value of the first pixel is V1i, a function indicating sensitivity with which the first pixel is influenced by the second pixels is f(V1i), number of the second pixels is N, an input gradation value of the second pixels is V2i, and a coefficient indicating strength of influence that the second pixels exert on the first pixel is Sp:
$$V 1 o = V 1 i - f ( V 1 i ) {\sum }_{p = 1}^{N} S p ( V 2 i - V 1 i ) \qquad ( 3 )$$

7. The display system according to claim 6, wherein the function f(V1i) is indicated by Expression (4) below when the input gradation value V1i of the first pixel is x, and coefficients set in advance in accordance with the sensitivity with which the first pixel is influenced by the second pixels are A, C, D, and E:
f(V1i)=f(x)=Ax³+Cx²+Dx+E (4)

8. The display system according to claim 5, wherein the pixels include a first pixel for displaying a first color, a second pixel for displaying a second color different from the first color, and a third pixel for displaying a third color, the third color being different from the first color and the second color.
